(19) United States
(12) Patent Application Publication
(10) Pub. No.: US 2026/0308731 A1
(43) Pub. Date: Oct. 8, 2026

(54) INFILTRATED COMPONENTS

(71) Applicant: OERLIKON METCO (US) INC., Westbury, NY (US)

(72) Inventors: Andrew BELL, Devon (GB); Zhongming WANG, Houston, TX (US); James VECCHIO, San Diego, CA (US); Bernard LAROUCHE, Meiningen (DE); Justin Lee CHENEY, Encinitas, CA (US); Zhe ZHANG, Katy, TX (US)

(73) Assignee: OERLIKON METCO (US) INC., Westbury, NY (US)

(21) Appl. No.: 19/481,482

(22) PCT Filed: Apr. 26, 2024
(86) PCT No.: PCT/US2024/026611

§ 371 Date: Nov. 4, 2025

Related U.S. Application Data
(60) Provisional application No. 63/464,319, filed on May 5, 2023.

(51) Int. Cl. C22C 29/08; C01B 32/949; C22C 1/10; C22C 9/05; C22C 29/06

(52) U.S. Cl. CPC C22C 29/08; C01B 32/949; C22C 1/1068; C22C 9/05; C22C 29/067; C01P 2004/02; C01P 2004/03; C01P 2004/54; C01P 2004/61; C01P 2004/62; C01P 2006/21

(57) ABSTRACT

A method for manufacturing articles comprising heat-treated tungsten carbide particles in a matrix of a binding alloy is provided. The method comprises liquid metal infiltration. The tungsten carbide particles are preferably spheroidal, and the binding alloy preferably comprises copper. The tungsten carbide particles are preferably heat-treated prior to, or during, the liquid metal infiltration process. Also provided are articles prepared by the method.

### FIELD OF THE INVENTION

The subject matter relates to components manufactured by infiltrating a metallic alloy through a tungsten carbide powder bed to form a metal matrix composite (MMC).

### BACKGROUND OF THE INVENTION

There are several known methods for manufacturing components in applications and industries that require high wear resistance and/or high strength. These include sintering, substrate cladding, and liquid metal infiltration.

Sintering: Sintered WC components or cemented WC components, most typically a blend of WC and Co or Ni, are used for a variety of applications and industries where wear resistance and/or high strength is needed. They are formed through a multi-step process that comprises one or more of:
1. Powder preparation
2. Blending
3. Conglomeration
4. Compaction
5. Pre-sintering
6. Forming
7. Sintering
8. Hot Isostatic Pressure
9. Finishing

Preparation of the hard-phase tungsten mono-carbide (WC) includes attrition, screening and cleaning. Similar methods are carried out on the soft-phase material such as cobalt and nickel (1). Blending (2) of both materials provides through mixing and a fugitive binder such as wax, after a period of time. Materials are conglomerated into small balls, or ready to press (RTP) powder via a spray drying tower (3). The RTP is loaded into a mold often within a uniaxial press. Material loading is often achieved robotically. After pressing, a green-state component is extruded from the press (6). De-waxing and sintering (7) is followed by high pressure sintering (8) to form a sintered part. Finally, and due a high volumetric contraction, the parts are machined, tumbled and generally finished (9).

Typically, when the material properties of the sintered composite are determined, the grain size of the Mono-Tungsten Carbide is used. Mono-Tungsten Carbide has a resistance to localized indentation of about 1800-2000 HV, which plastically deforms at room temperature. Typical grain size range is 0.0001 to 0.010 mm and most typically 0.001 to 0.004 mm. Strength and ductility of the composite is modified by the grain size of the Mono-Tungsten Carbide and the proportion of the soft phase. The soft phase range can be in the range of 5 wt. % to 35 wt. % and most typically 6 wt. % to 10 wt. %. The overall wear resistance of the composite is limited by the hard phase hardness.

Substrate Cladding: There are multiple methods of kinetic and thermal processes to form a wear resistant surface on a substrate. These include but are not limited to; High Velocity Oxy-Fuel (HVOF), Plasma Transferred Arc (PTA), Thermal Spray (TS), Metal Inert Gas (MIS), and Physical Vapor Deposition (PVD). The complexity of a typical manufacturing method can be understood in the following example. During drilling, a Rotary Steerable tool is used to drill to a target location. Mechanical engagement of retractable pads on the side of the tool enable it to be steered. A typical manufacturing route includes:
1. Machining a stainless steel substrate
2. Locating diamond monoliths within a recess
3. Applying a cladding to the recess and around the diamond monoliths
4. Grinding the hardfacing
5. Inserting a carbide insert in a bore that forms a bush and fulcrum

Machining of steel to a complex geometry (1) including a recess and bores that pivots the pad. Diamond or carbide monoliths are attached to the recess (2). A cladding layer is applied over and around the monoliths (3). Grinding to an exact profile is then carried out by removing excess cladding and the monoliths (4). During processing, a cemented carbide insert is applied to a bore to avoid wear to the steel (5) and forms a fulcrum.

The substrate's strength and ductility is generally considered relative the applied stress of the application. Substrate materials can include; Titanium, Aluminum and Steel. Steel is often used in the heat-treated condition and can have a tensile proof stress of the order of 100,000 to 200,000 psi. Alloying and different treatments give rise to increase in strength. Most metallic substrates are also ductile and plastically deform prior to failure.

Cladding or coatings utilize hard phases such as Tungsten Carbide, Boron Nitride and Chromium Carbide. Others include combinations of metals and oxides, borides, nitrides and carbides. Where such hard phases are added to the coating, their volume within the resulting surface enhanced composite is limited by the application method. Typically a range of about 40 vol. % to 50 vol. % is observed. This is a relatively low content when compared with sintered composites and packed liquid metal infiltrated composites, that range between about 65 vol. % to 95 vol. %.

Liquid Metal Infiltration: Liquid metal infiltration has been used for either a free-standing monolith or a substrate backed monolith. The basic steps are:
1. Forming a powder bed
2. Melting a binder that then is in direct or indirect contact with the powder bed
3. Allowing sufficient time for the binder to wet and fill the void space within the powder bed via capillary action
4. Cooling below the binder's solidus to for a Metal Matrix Composite

The powder bed (1) can be formed using a binding agent and then formed by pressing or placing using Additive Manufacturing to form a green body. Such binding agents are lost, evaporated or burned off during subsequent heating of the part. Agents can include; polyethylene glycol, wax, paraffin or cellulose based materials. Typically, and more simply, a mold is formed and filled with a powder. The powder can be metallic, ceramic or a cermet, and generally forms a hardphase within the resulting composite. In cases where a combination of strength and wear resistance is required the powder may be formed from crushed tungsten carbide or spherical cast tungsten carbide or a combination thereof. The mold itself and any internal mold furniture can be made from hard-carbon, ceramics, sand, and steel. The mold parts can be machined, formed by additive manufacturing, created using a lost wax process or processed using a resin that hardens during modest heating or cured under a gas such as carbon dioxide. Internal or external parts may be added within or close to the powder bed to form a substrate

The binder or infiltrant (2) can form a molten bath and the powder bed (1) placed in contact with it, or completely immersed. In another technique that is typically encountered in the manufacture of Drill Bit bodies, the infiltrant is placed on top of a powder and the entire part heated such that the binder melts and forms a metal matrix composite on cooling.

In some cases, the powder can be placed into a mold, the infiltrant placed on top and a positive pressure applied prior to, during and/or after infiltration (preferably throughout). In some cases, the powder is consolidated by hand tapping or vibrocompaction to maximize the hardphase content.

Once the infiltrant is liquid, in part (3) a complete infiltration path is made depending on the wettability of the hardphase with the infiltrant, the amount of superheat, the hydrostatic pressure and the soak time. The amount of time sufficient to provide complete infiltration can be determined by an ordinarily skilled worker using the present specification as a guide, and will depend on the materials used, and the article being manufactured. For example, for test coupons and small articles, an infiltration time of 15 minutes could be sufficient. Larger articles such a machine parts would generally take longer, such as about one hour. Cooling (4) can be done in still air, via a fan or through directional cooling via a water jet. This results in the creation of a metal matrix composite after solidification.

In another example of a part formed using liquid metal infiltration. A bearing used in down-hole motors is formed using a steel mold. An annular spacing is formed between two parts. This void is filled with metal powder and compacted. Binder is placed on the powder and the parts are heated via an induction coil or similar. On cooling a metal matrix composite.

FIG. 1 illustrates known configurations of the liquid metal infiltration process. A porous media 101 is placed in contact with either a liquid 102 or solid infiltrant 103. The porous media can be partially submerged (FIG. 1a), or fully submerged in the liquid infiltrant (FIG. 1b), or the solid infiltrant can be placed in contact with the porous media (FIG. 1c).

Metal Matrix Composites formed through liquid metal infiltration provide a very simple method of manufacture to form a free standing monolith or substrate backed monolith, when compared to that created using a multi-step cemented sintering operation. Conventional Metal Matrix Composites have generally not been able to compete with Sintered Cemented Tungsten Carbides and substrate clad components since a combination of a Metal Matrix Composite's properties are compromised and generally inferior. These deficiencies include but are not limited by; strength, ductility, plasticity, wear resistance, fracture toughness and thermal shock resistance. Typical Metal Matrix Composites show little ductility and are classed as brittle materials. During testing, little-to-no plastic deformation is encountered, and a linear elastic behavior is encountered followed by instantaneous failure. Strength is generally limited to a maximum of 160,000 p.s.i. when tested in flexure. Reliability is limited by flaw statistics and the overall strength of the composite determined using Weibull statistics. Typically, a Weibull Modulus of around 20 is achieved. This often limits their use in many engineering applications. Typically, liquid metal infiltration is undertaken at temperatures lower than 1180° C.

The metal matrix composite's mechanical properties are typically inferior to a typical clad substrate. The substrate's surface wear properties may not be satisfactory for the environment in which it operates: e.g., unsatisfactory corrosion, abrasion and erosion resistance. Hence the need for a coating or cladding.

While methods of manufacturing by liquid metal infiltration are well known, applications are generally limited to Drill Bits and Bearings.

It would be advantageous to utilize the simple method of liquid metal infiltration to form a monolith, or a substrate backed part, that has strength and ductility, as that would provide a surprising attractive alternative to conventional engineering substrates such as steel. Combining wear resistance that competes with a coated or clad substrate and a sintered tungsten carbide part opens the door to new and unexpected applications for liquid metal infiltrated composites.

### SUMMARY OF THE INVENTION

A cast tungsten carbide powder is provided comprising granules having a particle grain boundary area fraction of 20%-50%, and an average aspect ratio of less than 1.3. Also provided is a heat-treated cast tungsten carbide powder, prepared by heating a tungsten carbide powder, such as described above, to a temperature of 1000°−1250° C., preferably 1100-1250° C. or 1190-1250° C., for a period of 0.5-50 hours, under vacuum or a non-reactive atmosphere prior to liquid metal infiltration that forms a metal matrix composite. The transformation, results in the formation of metallic tungsten within the cast tungsten carbide particle.

Alternatively, transformation and property improvements to a tungsten carbide powder is provided comprising granules having a particle boundary area fraction of 20%-50%, and an average aspect ratio of less than 1.3 and a carbon content of between 3.0 and 4.5 wt. %. The transformation is provided during liquid metal infiltration when the tungsten carbide powder is in contact with a liquid metal at a temperature between 1000-1250° C., and preferably 1190°−1250° C. for a period of 0.5-50 hours.

Transformation of cast tungsten carbide properties either prior to or during liquid metal infiltration forms a tungsten metallic phase of 1-50 wt. %, preferably 5-50 wt. %, and most preferably 10-50 wt % within the cast tungsten carbide particles. The particles may or may not also contain a hemicarbide (W2C) phase. The resulting particles show increased toughness, thermal conductivity and thermal shock resistance compared to those that have not been transformed. These desirable properties are in turn transferred to the resulting metal matrix composite.

Some particular preferred embodiments include, e.g., a cast tungsten carbide powder that includes a tungsten carbide (monocarbide) phase; and a metallic tungsten phase that may or may not include a hemicarbide (W2C) phase.

In embodiments, the powder includes a metallic tungsten phase with the fraction no less than 1-10 wt. %, preferably no less than 11-20%, and most preferably no less than 21-50%.

The tungsten carbide powder, which may be a heat-treated tungsten carbide powder, preferably has a carbon content between 3.0 and 4.5 wt. %.

Also provided are compositions comprising a tungsten carbide powder and an alloy comprising 50-85 wt. % copper.

Also provided is a method of manufacturing a metal matrix composite article comprising, obtaining a cast tungsten carbide powder comprising a transformed cast tungsten carbide powder; heating the cast tungsten carbide powder in the presence of a binder alloy to a temperature and for a time sufficient for the binder alloy to melt and infiltrate the cast tungsten carbide powder, to form an infiltrated article; and obtaining the metal matrix composite article by cooling the infiltrated article to solidify the binder alloy, wherein the heat-treated tungsten carbide is prepared by heating a raw tungsten carbide powder with an aspect ratio less than 1.3, which comprises needle-like structures on its surface, to a temperature of 1000°−1250° C., preferably 1100-1250° or 1190-1250° C., for a period of 0.5-50 hours, under vacuum or a non-reactive atmosphere or in air; the cast tungsten carbide powder comprises at least 10 wt % of the transformed heat-treated tungsten carbide powder, based on total carbide in the tungsten carbide powder; and the binder alloy comprises 50-85 wt % copper.

Alternatively, during the liquid metal process, cast tungsten carbide particles can be transformed to up to 50 wt % of tungsten by ensuring a liquid phase is in contact with these particles for between 0.5-50 hours and 1000-1250° C., preferably 1190-1250° C.

In the method of manufacturing, heat-treated tungsten carbide powder preferably comprises granules having a grain boundary area fraction of 20%-50%, and an average aspect ratio of less than 1.3. In the method of manufacturing, the heat-treated tungsten carbide powder preferably has a surface topography comprising needle-like structures having an aspect ratio less than 1.3. In the method of manufacturing, the heat-treated tungsten carbide powder preferably has a surface topography comprising needle-like structures having an aspect ratio in the range of 1-1.3.

Also provided are metal matrix composite articles prepared by the methods of manufacturing.

Also provided is a metal matrix composite article comprising cast tungsten carbide particles in an alloy matrix, wherein the cast tungsten carbide particles include 10 wt % to 100 wt % heat-treated tungsten carbide particles based on total weight of the tungsten carbide particles, the heat-treated tungsten carbide particles had been heated to a temperature of 1000°−1250° C., and preferably 1100-1250° C. or 1190-1250° C., for a period of 0.5-50 hours, under vacuum or a non-reactive atmosphere, the tungsten carbide particles or the heat-treated tungsten particles have an aspect ratio of 1 to 1.3, and the alloy matrix comprises 50-85 wt % copper.

Also provided, the cast tungsten carbide is in-situ heat treated during the liquid metal infiltration process and when in contact with a liquid metal to form a MMC with the infiltration temperature between 1000-1250° C., preferably 1190-1250° C., and soak time between 0.5-50 hours.

The metal matrix composite article preferably exhibits a wear resistance of 6 mm³ or less, when measured according to ASTM G65. The metal matrix composite article preferably exhibits a volume loss of 0.8 cc lor less, when measured according to ASTM B611. The metal matrix composite article preferably exhibits a Charpy impact toughness of at least 6.75 J.

In some aspects, the metal matrix composite article comprises tungsten carbide particles having a D50 of between 1 μm and 10 μm, and a TRS greater than or equal to 360 ksi. In some aspects, the metal matrix composite article comprises tungsten carbide particles having a D50 of between 11 μm and 20 μm, and a TRS greater than or equal to 280 ksi. In some aspects, the metal matrix composite article comprises tungsten carbide particles having a D50 of between 21 μm and 40 μm, and a TRS greater than or equal to 230 ksi. In some aspects, the metal matrix composite article comprises tungsten carbide particles having a D50 of between 41 μm and 60 μm, and a TRS greater than or equal to 180 ksi. In some aspects, the metal matrix composite article comprises tungsten carbide particles having a D50 of between 61 μm and 80 μm, and a TRS greater than or equal to 160 ksi. In some aspects, the metal matrix composite article comprises tungsten carbide particles having a D50 of between 81 μm and 100 μm, and a TRS greater than or equal to 140 ksi. In some aspects, the metal matrix composite article comprises tungsten carbide particles having a D50 of between 111 μm and 200 μm, and a TRS greater than or equal to 100 ksi. In some aspects, the metal matrix composite article comprises tungsten carbide particles having a D50 of between 201 μm and 500 μm, and a TRS greater than or equal to 80 ksi. In some aspects, the metal matrix composite article comprises tungsten carbide particles having a D50 of between 501 μm and 1000 μm, and a TRS greater than or equal to 60 ksi. In some aspects, the metal matrix composite article comprises tungsten carbide particles having a D50 of between 1001 μm and 2000 μm, and a TRS greater than or equal to 50 ksi.

In some embodiments, the metal matrix composite article contains different composites in different regions of the part to provide the desired properties during service.

### BRIEF DESCRIPTION OF THE DRAWINGS

FIG. 1 illustrates known configurations of the liquid metal infiltration process. A porous medium can be partially submerged in a liquid infiltrant (FIG. 1a), fully submerged in a liquid infiltrant (FIG. 1b), or the solid infiltrant can be placed in contact with the porous media (FIG. 1c).

FIG. 2 shows example components made of a substrate cladding component FIG. 2a in which part of the component is cladded with a WC layer 202 onto a steel part 203; and a cemented WC component FIG. 2b in which the whole component is made from cemented WC.

FIG. 3 shows an example of a drawing of a bottle opener with two composite materials.

FIG. 4 is an SEM image of a conventional metal powder with angular particles.

FIG. 5 is an optical micrograph of a conventional MMC prepared using angular particles.

FIG. 6 is an optical micrograph of an MMC prepared using spherical particles.

FIG. 7 is an SEM image of a conventional spherical carbide.

FIG. 8 is an SEM image of a textured spherical carbide according to the present disclosure.

FIG. 9 is a binary image of FIG. 7.

FIG. 10 is a binary image of FIG. 8.

FIG. 11 provides photographs of Vickers hardness indentations on WC particles in MMC articles where the WC powder had not been subjected to heat treatment (FIGS. 11a-11d) and where the WC powder had been subjected to heat treatment (FIGS. 11e-11h).

FIG. 12 shows the comparison of the sliding distances after ASTM B611 wear test between the medium size cemented tungsten carbide with 10 wt. % Cobalt and the infiltrated component with heat-treated spherical cast tungsten carbides.

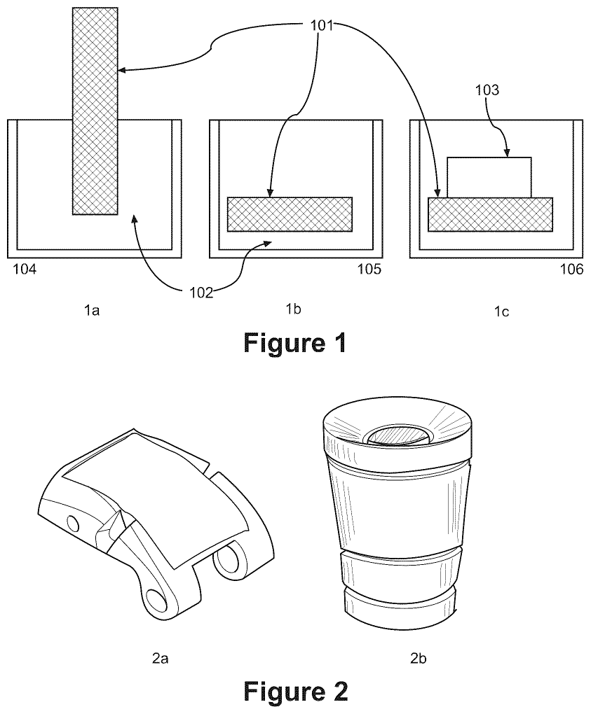

### DETAILED DESCRIPTION

Disclosed herein are embodiments of infiltrated components that meet or exceed performance attributes of sintered WC components and clad substrates. In contrast to the typical laborious methods used to make sintered WC components and clad substrates, this disclosure provides an infiltration process. Described is a series of efforts that can transition to a lower cost infiltration process—a technique currently reserved for drill bit bodies and bearings—into a performance regime that matches and exceeds sintered components, clad substrates and the properties of a substrate itself.

The present invention is applicable in a wide variety of applications and industries. FIG. 2 provides two non-limiting illustrative examples of a substrate cladding component. In FIG. 2b, part of the component is a WC layer 202 cladded onto part 203 (e.g., steel). FIG. 2b illustrates a component wholly made from cemented WC. The example substrate cladding component of FIG. 2a is a retractable pad used in rotary steerable tools in the oil and gas industry. The example cemented WC component of FIG. 2b is a fracking valve seat also used in the oil and gas industry. The infiltrated component described herein can be used to make both example components replacing the current methods of manufacture. It will be understood that for a part that is cladded with a WC containing layer (e.g., a retractable pad of FIG. 2a), the infiltrated component can be used to manufacture the entire component and not just the cladding layer, thereby replacing all or a portion of the, e.g., steel portion, of the component as well.

In some embodiments of this invention, certain processes common to the manufacture of cemented WC are preferably avoided. In some embodiments, the infiltrated component is preferably made without sintering and/or hot isostatic pressing. In some embodiments, the infiltrated component is preferably made without any welding process such as MIG, TIG open arc welding, PTA, and/or laser cladding. In some embodiments, the infiltrated component is preferably made without any thermal spray processes such as TWAS, HVOF, and/or plasma spray. In some embodiments, the infiltrated component is preferably made without any vapor deposited processes such as CVD and PVD.

In some embodiments, the component is used for a wear resistant part and is characterized by a high wear resistance quantified by ASTM G65 dry sand abrasion testing and/or ASTM B611 high stress abrasion testing. In some embodiments, the ASTM G65 volume loss of the component is 6 mm³ or lower, 5 mm³ or lower, 4 mm³ or lower, or 3 mm³ or lower. The ASTM G65 volume loss of the component will generally be 0 mm³ or higher, 1 mm³ or higher, 2 mm³ or higher, or 3 mm³ or higher. Ranges formed from these values (with inclusive or exclusive endpoints) are also included, such as ASTM G65 volume losses of 0 mm³ to 6 mm³, 0 mm³ to 5 mm³, 0 mm³ to 4 mm³, 0 mm³ to 3 mm³, 1 mm³ to 6 mm³, 2 mm³ to 6 mm³, 3 mm³ to 6 mm³, and 1 mm³ to 5 mm³.

High stress abrasion testing, measured according to ASTM B611, measures volume loss typically in cubic centimeters (cc). The ASTM B611 volume loss is preferably less than or equal to 0.8 cc, 0.75 cc, or 0.65 cc. The ASTM B611 volume loss is preferably greater than or equal to 0 cc, 0.05 cc, 0.1 cc, 0.2 cc, 0.4 cc, or 0.45 cc. Ranges formed from these values (with inclusive or exclusive endpoints) are also included, such as less than 0.8 cc, 0.8 cc or less, less than 0.75 cc, 0.75 cc or less, less than 0.65 cc, 0.65 cc or less, 0.8-0.05 cc, 0.75-0.1 cc, 0.65-0.1 cc, and 0.05 to less than 0.8 cc.

In the present disclosure, the size of the spherical cast tungsten particles used in the component may range between 1 to 2000 μm. or may range between about 1 to 200 μm. The variation of the size of the spherical cast tungsten particle can affect the transverse rupture strength (TRS) of the final infiltrated MMC. The Transverse Rupture Strength (TRS) is measured by applying a central force on a cylindrical bar. A resulting tensile stress beneath the applied force is increased until failure. The failure stress is calculated from the applied force and geometry of the test bar. Such a technique is described in detail in ASTM B406 for small cubic test pieces that are generally used to measure the TRS of cemented tungsten carbides. For liquid metal infiltrated parts, internal standards using cylinders are often applied.

Determining the powder particle size distribution is well within the capability of a person of ordinary skill in this field, and such persons would be familiar with equipment and methods for doing so. One preferred method includes use of laser light scattering, such as a MicroTrac device per ASTM B822, which is hereby incorporated by reference in its entirety. Different measures of particle size can be determined from various points on the curve obtained by this method. Three such points include:
D10 or 10th percentile particle diameter (μm),
D50 or average particle diameter (μm), and
D90 or 90th percentile particle diameter (μm).

Unless other wise stated, particle sizes herein will generally be the average particle diameter, D50. As a general matter, choice of tungsten carbide powder particle size can affect properties of the MMC article made from the powder. For example, as is known in the field, all other things being the same, there is an inverse relationship between carbide powder particle size and component strength. Thus, components made from finer (smaller D50) carbide powders tend to exhibit greater strength than components made from coarser (larger D50) carbide powders. On the other hand, smaller particle sizes can lead to a decrease in toughness, since larger grains are tougher in cemented tungsten carbides. The D50 of tungsten carbide particles selected will generally depend on the particular application intended, and can be chosen as necessary by a person of ordinary skill in the field. Quite literally, one size does not fit all.

Accordingly, tungsten carbide particles are provided in a wide range of particles sizes and ranges, for a variety of uses. Some tungsten carbide particle sizes include 1 μm, 5 μm, 10 μm, 15 μm, 20 μm, 30 μm, 40 μm, 50 μm, 60 μm, 70 μm, 80 μm, 90 μm, 100 μm, 120 μm, 140 μm, 160 μm, 180 μm, 200 μm, 250 μm, 500 μm, 1000 μm and 2000 μm, all of which may be increased or decreased by 1 μm. Ranges (inclusive and exclusive of endpoints) formed from any two of these values are also contemplated, such as 1 μm to 10 μm, 10 μm or 11 μm to 20 μm, 11 μm to 20 μm, 20 μm to 40 μm, 21 μm to 39 μm, 40 μm to 60 μm, 60 μm to 80 μm, 80 μm to 100 μm, and 100 μm to 200 μm, 200 μm to 500 μm, 500 μm to 1000 μm and 1000 μm to 2000 μm.

In some embodiments, a component made from spherical cast tungsten carbide particles having an average particle size (D50) between 1 μm and 10 μm, has a TRS greater than or equal to 360 ksi (or about 360 ksi), greater than or equal to 530 ksi (or about 530 ksi), or greater than or equal to 700 ksi (or about 700 ksi). Higher TRSs are also contemplated. As a practical matter, the TRS will generally be less than 1000 ksi.

In some embodiments, a component made from spherical cast tungsten carbide particles having an average particle size (D50) between 11 μm and 20 μm, has a TRS greater than or equal to 280 ksi (or about 280 ksi), greater than or equal to 365 ksi (or about 365 ksi), or greater than or equal to 450 ksi (or about 450 ksi). Higher TRSs are also contemplated. As a practical matter, the TRS will generally be less than 700 ksi.

In some embodiments, a component made from spherical cast tungsten carbide particles having an average particle size (D50) between 21 μm and 40 μm, has a TRS greater than or equal to 230 ksi (or about 230 ksi), greater than or equal to 260 ksi (or about ksi), or greater than or equal to 290 ksi (or about 290 ksi). Higher TRSs are also contemplated. As a practical matter, the TRS will generally be less than 450 ksi.

In some embodiments, a component made from spherical cast tungsten carbide particles having an average particle size (D50) between 41 μm and 60 μm, has a TRS greater than or equal to 180 ksi (or about 180 ksi), greater than or equal to 200 ksi (or about 200 ksi), or greater than or equal to 220 ksi (or about 220 ksi). Higher TRSs are also contemplated. As a practical matter, the TRS will generally be less than 350 ksi.

In some embodiments, a component made from spherical cast tungsten carbide particles having an average particle size (D50) between 61 μm and 80 μm, has a TRS greater than or equal to 160 ksi (or about 160 ksi), greater than or equal to 170 ksi (or about 170 ksi), or greater than or equal to 180 ksi (or about 180 ksi). Higher TRSs are also contemplated. As a practical matter, the TRS will generally be less than 300 ksi.

In some embodiments, a component made from spherical cast tungsten carbide particles having an average particle size (D50) between 81 μm and 100 μm, has a TRS greater than or equal to 140 ksi (or about 140 ksi), greater than or equal to 150 ksi (or about 150 ksi), or greater than or equal to 160 ksi (or about 160 ksi). Higher TRSs are also contemplated. As a practical matter, the TRS will generally be less than 250 ksi.

In some embodiments, a component made from spherical cast tungsten carbide particles having an average particle size (D50) between 101 μm and 200 μm, has a TRS greater than or equal to 100 ksi (or about 100 ksi), greater than or equal to 120 ksi (or about 120 ksi), or greater than or equal to 140 ksi (or about 140 ksi). Higher TRSs are also contemplated. As a practical matter, the TRS will generally be less than 200 ksi.

In some embodiments, a component made from spherical cast tungsten carbide particles having an average particle size (D50) between 201 μm and 500 μm, has a TRS greater than or equal to 80 ksi (or about 80 ksi), greater than or equal to 90 ksi (or about 90 ksi), or greater than or equal to 95 ksi (or about 95 ksi). Higher TRSs are also contemplated. As a practical matter, the TRS will generally be less than 100 ksi.

In some embodiments, a component made from spherical cast tungsten carbide particles having an average particle size (D50) between 501 μm and 1000 μm, has a TRS greater than or equal to 60 ksi (or about 60 ksi), greater than or equal to 70 ksi (or about 70 ksi), or greater than or equal to 75 ksi (or about 75 ksi). Higher TRSs also contemplated. As a practical matter, the TRS will generally be less than 80 ksi.

In some embodiments, a component made from spherical cast tungsten carbide particles having an average particle size (D50) between 1001 μm and 2000 μm, has a TRS greater than or equal to 50 ksi (or about 50 ksi), greater than or equal to 55 ksi (or about 55 ksi). Higher TRSs are also contemplated. As a practical matter, the TRS will generally be less than 60 ksi.

In some embodiments the novel metal matrix composite is characterized by high toughness. Charpy impact testing is a typical method to evaluate material toughness and unnotched Charpy impact specimens were used to quantify the toughness of the disclosed component. In some embodiments the Charpy impact toughness exceeds 5.0 ft-lbf (or 6.75 or 6.8 J), in preferred embodiments the toughness exceeds 6.0 ft-lbf (or 8 or 8.1 J, in still preferred embodiments, the toughness exceeds 8.0 ft-lbf (or 10.75 or 10.8 J, and still preferably the component has a toughness which exceeds 9.0 ft-lbf (or 12 or 12.2 J), 10.0 ft-lbf (or 13.6 or 14 J), or 11.0 ft-lbf (or 14.9 or 15 J). While there is no preferred upper limit to toughness, as a practical matter, Charpy impact toughness will generally be less than 20.0 ft-lbf (or 27 or 27.1 J). Charpy impact toughness can be measured according to ASTM E23, without a V-notch, or by another suitable method.

The enhanced toughness is a key performance attribute which makes the disclosed component suitable for applications more typical to cemented tungsten carbide components. The enhanced toughness in combination with strength is not common to typical components made via the infiltration process. For example, industry leading infiltrated components used in the drill bit industry comprising the Cu53 copper binder and angular WC binder exhibit a toughness of 3.3 ft-lbf (or 4.47 or 4.5 J) in comparable unnotched Charpy impact testing. Utilizing spherical WC particles does enhance the toughness, up to 5.9 ft-lbf or 8.0 J. Utilizing the combined new binder and spherical textured carbides described in this disclosure increases the toughness still to 9.2 ft-lbf or 12.5 J. When spherical cast tungsten carbide particles are heat-treated between 1000-1250° C., and preferably 1190-1250° C. for between 0.5 and 50 hours the toughness improves again to 13.7 ft-lbf or 18.6 J. Thus, the component technology described herein has a toughness increase of 315% from the Cu53 copper-based binder and angular WC technology used today. This drastic increase enables the disclosed technology to be used for structural parts typically reserved for cemented tungsten carbide components.

In some embodiments, the component can be described by the constituents which are used to make the final components. In the infiltration process, carbide powder is placed into a mold of suitable material, typically graphite. It is further typical to vibrate the mold after introduction of carbide to allow the carbide to settle. A metallic alloy, typically copper-based, is placed on top of the carbide powder. Introduction of the assembly into a furnace allows the copper to melt and infiltrate into the free space in the carbide powder. Upon cooling, the assembly becomes a solid component of copper alloy and carbide powder strongly bound together. In one embodiment of this invention the carbide powder is tungsten carbide (WC) powder. In a preferred embodiment, the carbide powder has a textured as opposed to smooth surface. In another preferred embodiment, the carbide powder is spherical. In a still preferred embodiment, the carbide powder is spherical WC with a textured surface. In other preferred embodiments of the invention, the tungsten carbide is heat treated prior to introduction to the infiltration process. In still another preferred embodiment of the invention, the tungsten carbide is in-situ heat treated during the liquid metal infiltration process to form a MMC with the infiltration temperature between 1000-1250° C., preferably 1190-1250° C. or 1190-1250° C., and soak time between 0.5-50 hours. In another embodiment, a high copper binder alloy is used.

In another embodiment inserts are used in order to form the desired final shapes of the component. In some embodiments, these inserts are 3-D printed. These inserts can be ceramics (such as Alumina or Silicon Carbide), Sands (such as quartz or cerabeads), or a plastic. In some embodiments, these 3D printed sand inserts are placed within graphite containers which can comprise a base, sides, and a lid. The assembly of sand or ceramic molds and graphite further comprises the porous compact and binder material and said assembly can be heated to allow the infiltration process to occur forming the MMC composite in the desired shape.

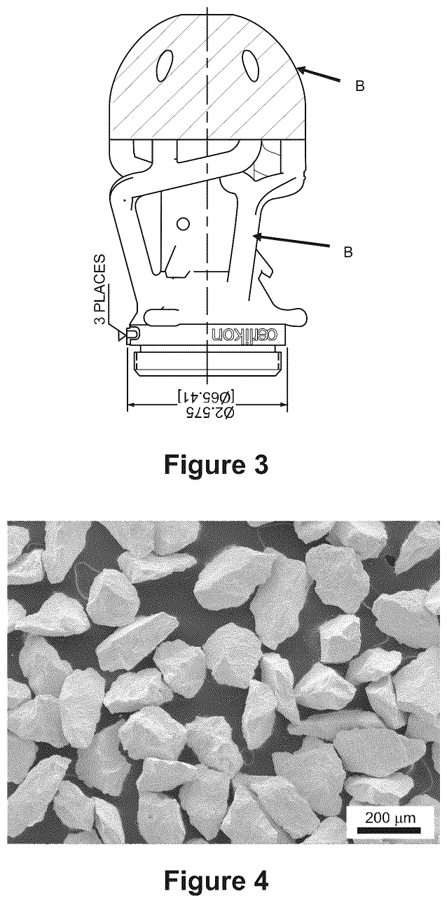

In another embodiment different materials are used within different locations within the mold and resulting part. For example, finer grained materials provide strength, while coarser grained materials improved wear resistance. FIG. 3 shows an example of a drawing of a bottle opener with two composite materials. In FIG. 3, composite material A has a high wear resistance while composite material B exhibits a high strength. In some embodiments, the infiltrated component consists of a region with high strength and another region with high abrasion resistance. The high strength region has a D50 of 1-100 μm, and a TRS of 140-1000 ksi, and an ASTM B611 volume loss of 0.65-0.80 cc. The high abrasion resistance region has an ASTM B611 volume loss of 0.10-0.65 cc, a D50 of 100-2000 μm, and a TRS of 50-140 ksi. In some other embodiments, the infiltrated components consist of a region with non-heat-treated tungsten carbide and another region with 10-100 wt. % heat-treated tungsten carbide of the total weight of the tungsten carbide of that region. In still another embodiment, the infiltrated component consists of several regions with different fractions of heat-treated tungsten carbide. For example, in one region of the infiltrated component, it contains 40 wt. % of the heat-treated tungsten carbide. In another region of the infiltrated component, it contains 100 wt. % of the heat-treated tungsten carbide. In still another region of the infiltrated component, it contains 0 wt. % of heat-treated tungsten carbide.

### Carbide Powder Morphology:

In some embodiments of this invention the carbides of the component have a spheroidal morphology. Spheroidal carbides for use according to the present disclosure may be prepared from carbide powders such as disclosed in WO 2021/173515 (incorporated herein in its entirety) may be used.

The spheroidal or substantially spherical fused tungsten carbide particles can generally be made from regular fused tungsten carbide powder or a mixture of tungsten, mono tungsten carbide and/or carbon. In some embodiments, the spheroidal or substantially spherical fused tungsten carbide particles can have a composition of combined carbon from 3.7 to 4.2 (or about 3.7 to 4.2) wt. %, with tungsten being the balance. The particles can be produced via a number of methods. In some methods, a mixture of tungsten powder blended with mono tungsten carbide and carbon powder is melted first. The molten mixture is then atomized by a rotation atomizing process or an ultra-high temperature melting & atomizing process. These processes spheroidizes molten tungsten carbide into spheroidal or substantially spherical fused tungsten carbide particles during the rapid solidification process due to surface tension. Other methods may be based on the modification of regular fused tungsten carbide powder. Plasma spraying, electric induction or electric resistance furnace melting is applied during the spheroidization process to obtain fine spheroidal or substantially spherical fused tungsten carbide particles.

As described herein, “sphericity” can be defined by an aspect ratio of the spheroidal or substantially spherical particles. The aspect ratio can be a ratio of a first length along a major axis to a second length along a minor axis, or a ratio of the longest axis length to the shortest axis length, of the spheroidal or substantially spherical particles. For example, a “perfectly” spherical particle would have an aspect ratio of exactly 1.0. On the other hand, “angular” particles, such as discussed above in the art, have an aspect ratio of at least 1.30.

In embodiments of the disclosure, spheroidal or substantially spherical fused tungsten carbide particles disclosed herein can have an aspect ratio of 1.30 (or about 1.30) or lower. In some embodiments, a spherical fused tungsten carbide can have an aspect ratio of 1.20 (or about 1.20) or lower. In some embodiments, a spherical fused tungsten carbide can have an aspect ratio of 1.10 (or about 1.10) or lower. In some embodiments, a spherical fused tungsten carbide can have an aspect ratio of 1.05 (or about 1.05) or lower. The aspect ratio can also have a value in a range defined by any two of these values. The aspect ratio as disclosed herein can represent an average value of aspect ratios of a plurality of fused tungsten carbide particles. In some embodiments, each of the particles can have an aspect ratio as disclosed herein. Some upper values of the aspect ratio include 1.3, 1.2, 1.1, and 1.05. Lower values include 1.2, 1.1, 1.05, with an understood lowest value of 1. Ranges (inclusive and exclusive of endpoints) formed from any two of these values are also contemplated, such as less than 1.3, less than or equal to 1.3, less than 1.2, 1.05 to 1.3, 1 to 1.05 (or equivalently, “up to 1.05,” or “1.05 or less”).

The aspect ratio can be determined by an ordinarily skilled practitioner by any suitable method. For example, aspect ratio can be determined from a visual or computer-assisted analysis of a photo-micrograph of a tungsten carbide powder.

The spheroidal or substantially spherical fused tungsten carbide powder specific density can be around 16.5 g/cm³ with micro-hardness advantageously ranging from 2,700-3,300 HV (or about 2,700-about 3,300 HV). These properties can be attributed to, among other things, the particle shape and internal microstructure resulting from the spheroidization processes described above. In other embodiments, lower hardness tungsten carbide is used with hardnesses ranging from 1,900-2,300 HV; the reduction of hardness being due to a heat treatment. Generally, MMCs containing spheroidal or substantially spherical fused tungsten carbide particles are more wear resistant than those that contain angular fused tungsten carbide for particles having a comparable size and fraction. In the following, various microstructural distinctions between conventional angular tungsten carbide particles and MMCs formed therefrom, and spheroidal or substantially spherical tungsten carbide particles and MMCs formed therefrom according to embodiments, are described.

FIG. 4 is a scanning electron microscope (SEM) image of a conventional metal powder. As shown, the powder is angular.

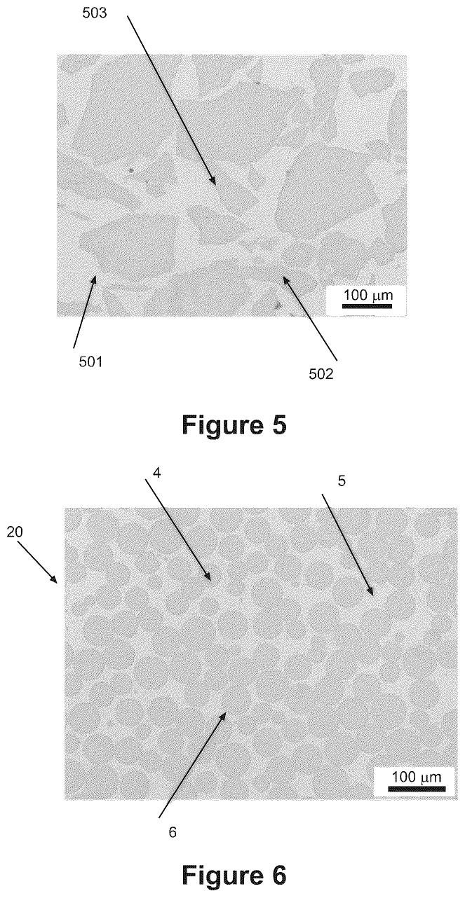

FIG. 5 is an optical micrograph of a conventional MMC prepared using known metallographic techniques. As shown, the MMC includes a soft phase 501, a particulate phase 502 (formed from a powder similar to that shown in FIG. 4), and a particulate-to-soft phase interface 503. Soft phase can be formed from a matrix material that is first melted and subsequently cooled. Thus, the MMC of FIG. 5 includes two principle phases: the soft phase 501 is formed through the liquid metal infiltration of the particulate phase 502.

The particulate phase can include metal carbides, borides or oxides. For example, the particular phase can include tungsten carbides including: mono tungsten carbide, fused tungsten carbide and/or cemented tungsten carbide. The tungsten carbide particles have typically been angular, as shown in FIG. 4. Between the soft phase and the particulate phase there is an interface. As described herein, the inventors have unexpectedly discovered that all three can contribute to the strength and wear properties of the MMC.

FIG. 6 illustrates an optical micrograph of a metal matrix composite (MMC) 20 prepared using spheroidal or substantially spherical carbide particles according to embodiments. As shown, the MMC 20 includes spheroidal or substantially spherical fused tungsten carbide particles 4 and a soft phase 5, which are combined to form the metal matrix composite (MMC) 20. The MMC 20 additionally includes a spheroidal or substantially spherical fused tungsten carbide-to-soft phase interface 6.

The interface 6 includes metallic or metallurgical bonds formed between the tungsten carbide particles 4 and the soft phase 5. It will be appreciated that the metallurgical bonds disclosed herein may comprise diffused atoms and/or atomic interactions, and may include chemical bonds formed between atoms of the particles 4 and the atoms of the soft phase. A metallurgical bond is more than a mere mechanical bond. Under such conditions, the component parts may be “wetted” to and by the metallic binding material.

### Carbide Particle Surface Morphology:

In some embodiments of this invention the carbides of the component have a uniquely textured surface morphology.

In this disclosure, the surface topography of spheroidal or substantially spherical fused tungsten carbide particles that form a powder was examined in detail. The surface condition of the novel spheroidal or substantially spherical fused tungsten carbide has a textured surface. The inventors have discovered that this texture can increase the available surface area at the interface 6 between the soft phase 5 and the spheroidal or substantially spherical fused tungsten carbide particles 4, as shown in FIG. 6.

FIG. 7 illustrates the surface morphology of a tungsten particle in a conventional MMC. As shown, the microstructure has “soccer-ball-like” topographical features of conventional fused tungsten carbide particles. The surface is relatively smooth, resulting in a low surface area and relatively low interfacial strength when incorporated within a MMC.

The strength of an MMC system can be associated with one or more of three different components: 1) the strength of the copper binder, the strength of the tungsten carbide particles, and the binding strength between the copper binder and the incorporated tungsten carbide particles. Thus, if the tungsten carbide particles and copper do not bond well, a failure can occur when the MMC undergoes high stress. By having carbide particles with larger surface area, the alloy has more area to bond to the carbide particles, thus substantially increasing the interfacial strength.

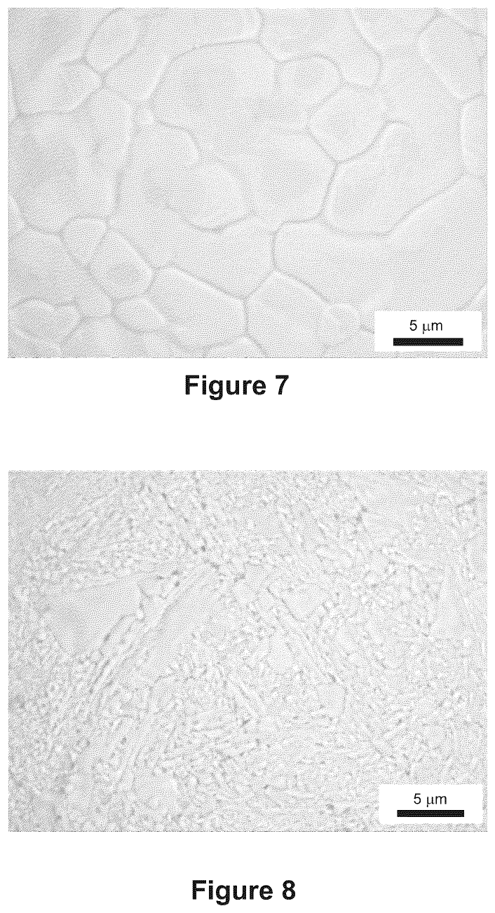

FIG. 8 illustrates the surface morphology of a spheroidal or substantially spherical tungsten particle in an MMC according to embodiments of this disclosure. As shown, the microstructure includes a “needle-like” topographical features (e.g., the texturing) of spheroidal or substantially spherical fused tungsten carbide. The surface is mostly textured with a fine-grained structure, resulting in a high surface area and better interfacial strength when incorporated within an MMC.

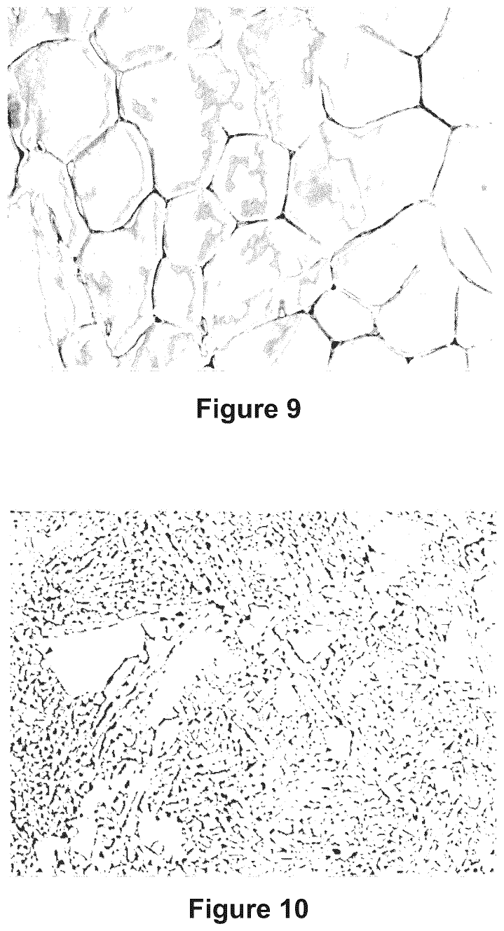

In order to quantify the spheroidal or substantially spherical fused tungsten carbide particles by their surface features, the fraction of a surface area in a fixed view field of an optical or SEM image that can be attributed to grain boundaries is analyzed. As described herein, an area fraction of grain boundary refers to the area in an image, e.g., an optical or SEM image, of a surface of a sample, e.g., the surface of a tungsten carbide particle, that can be attributed to grain boundaries. The area fraction of grain boundary can be quantified using images, e.g., high contrast or binary images such as those shown in FIG. 9 and FIG. 10. For example, the number of dark pixels as a fraction of a total number of pixels within an imaged field can correspond to the area fraction of grain boundary. The inventors have discovered that the conventional “soccer-ball-like” surface morphology of tungsten carbide particles leads to a relatively low area fraction of grain boundary on the surface of the tungsten carbide particles, e.g., less than 5%. On the other hand, tungsten carbide particles with “needle-like” surface morphology have a relatively high area fraction of grain boundary on the surface of the tungsten carbide particles, e.g., over 10% (or about 10%).

For example, the area fraction of the grain boundary in FIG. 7 is 3.6% while the value in FIG. 8 is 14.2%. FIG. 9 is a binary image of FIG. 7. FIG. 10 is a binary image of FIG. 8, which includes an analyzed area fraction of 14.2% and variation of 9.4 when divided into nine parts.

For an object of a given volume, spheres have the lowest mathematically possible area-to-volume ratio. Thus, one would expect spherical carbide particles to have low grain boundary area fractions. However, the inventors have discovered that the needle-like surface morphology of the tungsten carbide particles results in an unexpectedly high surface area of the tungsten particle carbide particles, which in turn gives rise to the high grain boundary area fraction. Thus, it is possible to provide tungsten carbide particles that are both spherical, and exhibit high grain boundary areas. The high grain boundary area fraction can be proportional to the amount of high strength interfaces formed between the tungsten carbide particles and the metal matrix, and can in turn be proportional to the mechanical and tribological properties of the MMCs, including the TRS and the erosion resistance.

Additionally, according to some embodiments, the needle-like topography comprises needle-like structures that are elongated along surfaces of the tungsten carbide particles. The needle-like structures have at least a portion length portion having a length exceeding, e.g., 0.5, 1, 2, 3, 4, 5 μm, or a value in a range defined by any two of these values, while having a width that is less than 2, 1, 0.5, 0.2, 0.1 μm, or a value in a range defined by any two of these values. The needle-like structures may have an aspect ratio of the longest length to the smallest width that exceeds 2, 5, 10, 20, or a value in a range defined by any two of these values.

In some embodiments, the spheroidal or substantially spherical fused tungsten carbide particles can have a grain boundary area fraction of 5.0% (or about 5.0%) or greater. In some embodiments, the spheroidal or substantially spherical fused tungsten carbide particles have a grain boundary area fraction of 10.0% (or about 10.0%) or greater. In some embodiments, the spheroidal or substantially spherical fused tungsten carbide particles have a grain boundary area fraction of 12.0% (or about 12.0%) or greater. In some embodiments, the spheroidal or substantially spherical fused tungsten carbide particle have a grain boundary area fraction of 12.0% (or about 12.0%) or greater. In some embodiments, the spheroidal or substantially spherical fused tungsten carbide particle have a grain boundary area fraction of 20.0% (or about 20.0%) or greater. The grain boundary area fraction can also have a value in a range defined by any two of these values.

Additionally, the area fraction of the grain boundary of the carbide powder, preferably spheroidal powder, is preferably greater than, or equal to, 5%, 10%, 14%, 15%, 20%, or 25%. While there is no preferred upper limit to the grain boundary area fraction, it will generally be less than, or equal to, 50%, 40%, or 30%. Ranges (inclusive and exclusive of endpoints) formed from any two of these values are also contemplated, such as 5%-50%, 10%-40%, 5%-40%, 5%-30%, 10%-50%, 10%-40%, 10%-30%, 10%-25%, 10%-20%, 14%-60%, and 14%-30%.

### Transformation of Tungsten Carbide:

In some embodiments of this invention the component comprises carbides which are heat treated prior to, or during, the infiltration process. The heat treatment process enhances the properties of the component, most notably wear resistance and/or toughness.

The application of this heat treatment yields surprising results. For example, the hardness of the component is relatively unaffected, possibly only dropping slightly (compared to a component prepared without heat treat treatment), but the wear resistance increases appreciably. It has been found that heat treatment converts the W₂C+WC structure, two forms of tungsten carbide, into a W+WC structure, notably different in that it has metallic W and WC. Without being bound by theory, it is believed that these surprising results may be attributable to the conversion of W₂C+WC structure to W+WC structure. It is believed that heat treatment of tungsten carbide powders modifies the internal structure of the particles thereby increasing thermal conductivity and/or thermal shock resistance. Standard metal infiltration processes are conducted under conditions of temperature and time that are insufficient to confer the benefits of heat treatment. It is found that increasing temperatures and times to promote diffusion with the cast tungsten carbide, when the metal binder is in the liquid phase and beyond what conventional infiltration parameters can achieve similar wear resistance and toughness benefits.

In any event, the observation that heat treated carbide powders provide these unexpected results to components made by infiltration processes indicates that carbide powders heat treated as disclosed herein are unexpectedly different, both in structure and properties, from carbide powders that have not undergone heat treatment.

Heat treatment may take place in a non-oxidizing atmosphere, exposing the powder to a temperature of at least 1000° C. and up to 1250° C., preferably at least 1100° C. or 1190° C. and up to 1250° C., for 0.5-50 hours until partial or complete transformation of the W₂C (hemicarbide) phase is achieved.

It is preferable to conduct the heat treatment under vacuum (e.g., in a vacuum furnace), or in a non-reactive or reducing atmosphere, preferably free of oxygen, such as an argon atmosphere, preferably a low pressure argon atmosphere.

Manufacturing methods also include a single-step process in which the heat treatment is performed concurrently with the metal infiltration process. In this case, the metal infiltration process is modified, e.g., higher temperature and/or longer infiltration time, in order result in heat treatment of the tungsten carbide powder. For example, a metal infiltration process can be performed under conditions for heat treatment.

An infiltration process can use heat-treated carbide as the sole carbide. Use of blends of heat-treated carbide and non-heat-treated carbide is also contemplated. Thus, included in the present invention are combinations where heat-treated and non-heat-treated carbides are blended together to form the porous compact of the infiltration process. The amount of heat-treated carbide in a carbide powder can be 100 wt %, 90 wt. %, 80 wt %, 70 wt %, 60 wt %, 50 wt %, 40 wt %, 30 wt %, 20 wt % or 10 wt %, based on total weight of carbide powder, i.e., weight of hard particles such as tungsten carbide, e.g., W and all W carbides. Ranges (inclusive or exclusive of endpoints) formed from any two of these values are also contemplated. For example, when a blend of heat-treated and non-heat-treated carbide is used, the amount of heat-treated carbide can be in the range of 10-90 wt %, 10-50 wt %, 10-30 wt %, or 70-90 wt %.

Components made from carbide powder comprising, or consisting of, heat-treated carbide, are particularly useful for high stress applications such as bearings including thrust and radial bearings.

### Binder Alloy:

In some embodiments of this invention the component comprises a high copper content binder alloy.

In one embodiment of this invention, the binder alloy for forming a matrix of an MMC includes an elemental composition including a relatively high copper (Cu) concentration exceeding 55, 60, 65, 70, 75, 80, 85 weight percent (wt. %), or a value in a range defined by any of these values. The high Cu content provides improved thermal conductivity, among other advantages. Binder alloys such as disclosed in WO 2022/212588 (incorporated herein in its entirety) may also be used.

While elemental copper may offer one of the highest thermal conductivities, it may not offer one or more of the other desirable characteristics associated with the fabrication of the MMC or the resulting mechanical properties thereof. To improve various mechanical properties of the matrix including strength, hardness and abrasion resistance of the matrix of the MMC, which in turn improves the corresponding mechanical properties of the resulting MMC, as well as improving infiltration characteristics described above for forming the matrix in liquid state, the inventors have discovered a combination of alloying elements for alloying with Cu to form a feedstock alloy for forming the matrix. According to various embodiments, in addition to the relatively high Cu content described above, the elemental composition of the feedstock alloy for forming the matrix includes: tin (Sn) at a concentration exceeding 1.4 wt. %, nickel (Ni) at a concentration exceeding 3.5 wt. %, and manganese (Mn) at a concentration exceeding 5.6 wt. %. To maintain the high Cu content described above, the combined concentration of Sn, Ni and Mn does not exceed 20 wt. %, 30 wt. %, 40 wt. %, 45 wt. % or has a value in a range defined by any of these values, according to embodiments.

In some embodiments, an elemental composition of a feedstock alloy for forming a matrix of an MMC includes Sn at a concentration exceeding 1.4, 1.6, 1.7, 1.8, 1.9, 2.0, 2.1, 2.2, 2.3, 2.4, 2.6 wt. %, or having a concentration within a range defined by any of these values. For instance, the elemental composition includes Sn at 1.4-2.6 wt. %, 1.7-2.3 wt. %, or about 2.0 wt. %. The elemental composition of the feedstock alloy additionally includes Mn at a concentration exceeding 5.6, 6.4, 6.8, 7.2, 7, 6, 8.0, 8.4, 8.8, 9.2, 9.6, 10.4 wt. %, or a concentration within a range defined by any of these values. For instance, the elemental composition includes Mn at 5.6-10.4 wt. %, 6.8-9.2 wt. %, or about 8.0 wt. %. The elemental composition of the feedstock alloy additionally includes Ni at a concentration exceeding 3.5, 4.0, 4.3, 4.5, 4.7, 5.0, 5.3, 5.5, 5.8, 6.0, 6.5 wt. %, or a concentration in a range defined by any of these values. For instance, the elemental composition includes Ni at 3.5-6.5 wt. %, 4.3-5.8 wt. %, or about 5.0 wt. %.

In some embodiments, the elemental composition of the feedstock alloy may include additional elements, which may include incidental impurities, at a combined concentration less than 10 wt. %, 5 wt. %, 2 wt. %, 1 wt. % or a value in a range defined by any of these values. In some embodiments, Cu may be present as a balance of the elemental composition, in addition to the additional or impurity elements.

Advantageously, the relatively high Cu concentration of the feedstock can provide high thermal and/or electrical conductivity. It will be appreciated that the high thermal conductivity can be indirectly measured by measuring the electrical conductivity. According to embodiments, the feedstock has an electrical conductivity greater than 2.0 mega Siemens (MS)/meter (m), 2.5 MS/m, 3.0 MS/m, 3.5 MS/m, or a value in a range defined by any of these values. Without being bound to any theory, the feedstock can have thermal conductivity that can have a value related to the electrical conductivity through, e.g., Wiedemann-Franz law. According to embodiments, the feedstock can have thermal conductivity greater than 10 W/mK, 11 W/mK, 12 W/mK, 13 W/mK, 14 W/mK, 15 W/mK, 16 W/mK or a value in a range defined by any of these values.

The combined high strength and high thermal conductivity of the component provides additionally a high thermal shock resistance. In some embodiments the thermal shock resistance is 600 W/m or greater, in preferred embodiments the thermal shock resistance is 650 W/m or greater, and in still preferred embodiments, the thermal shock resistance is 700 W/m or greater.

When present in the disclosed amounts, the combination of Cu, Sn, Mn and Ni forms a feedstock alloy that can provide various advantages over relatively pure elemental Cu as a source of the matrix of an MMC. The advantages may include one or more of: lower melting temperature, lower contact angle with tungsten carbide and/or lower reactivity with tungsten carbide. The combination of elements can additionally provide advantages over relatively pure elemental Cu as source of the matrix of an MMC including one or more of: higher strength, higher abrasion resistance and/or higher hardness.

In some embodiments, the combination of the elements in the feedstock alloy can provide further advantages over elemental Cu when the elemental composition of the feedstock does not include one or more of Si, B and/or Zn, or when present, Si, B and/or Zn is present at a combined concentration less than 10 wt. %, 5 wt. %, 2 wt. %, 1 wt. % or a value in a range defined by any of these values.

In a still preferred embodiment of this invention the Co content of the binder is limited or preferably zero. In some embodiments the Co content of the binder is below 1 wt. %. In some embodiments the Co content of the binder is below 0.1 wt. %. In some embodiments the Co content of the binder is below 0.01 wt. %

Having the feedstock in the form of an alloy can be advantageous for lowering the melting temperature of the feedstock alloy, such that the MMC can be effectively formed at lower temperatures. The lower melting temperature of the feedstock in the form of an alloy can be advantageous for several reasons. One of the reasons is the compatibility with existing methods for manufacturing MMCs, including those described above. Due to the temperature constraints of some existing manufacturing methods, a feedstock for forming the matrix of an MMC that has a melting temperature exceeding 1300K may be difficult to fully melt to infiltrate the reinforcement particles for manufacturing into a matrix of an MMC. Thus, based on the melting temperatures of Cu, Mn and Ni, which are 1083° C. (1356 K), 1244° C. (1517 K), 1453° C. (1726 K), respectively, the inventors have found it advantageous for the feedstock including these elements to be in an alloy form that has a melting temperature lower than each of these elements. The inventors have found, advantageously, that the feedstock including the combination of Cu, Sn, Mn and Ni in the above-described elemental composition, when present as an alloy, can advantageously provide a feedstock alloy with a lower melting temperature to improve manufacturability. Thus, according to embodiments, the feedstock in the form of an alloy has a composition such that the alloy has a solidus temperature lower than a melting temperature of substantially pure Cu. In some embodiments, the solidus temperature of the alloy is lower than 1300 K, 1275K, 1250K, 1225K, 1200K, or a solidus temperature in a range defined by any of these values.

### Applications

The compositions and methods described herein can be used to manufacture a wide variety of components. The component can be a monolith entirely fabricated from the infiltration casted MMC, or can be a substrate material bonded to an MMC. Infiltration processes are typically used for drill bit bodies, and the present compositions and methods can be used to manufacture drill bit bodies. However, the unique performance regime of these compositions and methods allows the infiltrated components to be used in an expanded set of application areas.

Such applications include parts, e.g., small parts, including, but not limited to, turning tips, micro-drills, dipper cutters, and other cutters, knives, can tooling, wire dies, blades, water jet nozzles, and wear parts generally.

Such applications also include parts, e.g., medium-sized parts, including, but not limited to, fracking valves, valve sub-sea assemblies, mining inserts, pump bodies, and thrust bearings.

Such applications also include parts, e.g. larger parts, including, but not limited to, bearings, pads for rotary steerable tools, flow control valves and other valves, chokes, nozzles, and bushings.

Surface mining applications include the following components: Wear resistant sleeves and/or wear resistant hardfacing for slurry pipelines, inserts, valves, choke vales, seats, mud pump components including pump housing or impeller or mud pump components, ore feed chute components including chute blocks, separation screens including but not limited to rotary breaker screens, banana screens, and shaker screens, liners for autogenous grinding mills and semi-autogenous grinding mills, ground engaging tools and teeth and ground engaging tools and teeth, shrouds and adapters, wear plate and rock boxes including for buckets and dump truck liners, heel blocks on mining shovels, grader blades and hardfacing for grader blades, stacker reclaimers, sizer crushers, jaw crushers, ripper teeth, cutting edges, general wear packages for mining components and other comminution components.

Downstream oil and gas applications include the following components: Downhole casing and downhole casing, drill pipe and, mud motors, fracking pump sleeves, fracking impellers, fracking blender pumps, stop collars, drill bits and drill bit components, directional drilling equipment and coatings for directional drilling equipment including spiders, pads, stabilizers and centralizers, blow out preventers and coatings for blow out preventers and blow out preventer components including the shear rams, oil country tubular goods and coatings for oil country tubular goods, sucker rods and couplings, lift plungers, Neyrfor rotors, artificial lift casing, and ESP pump housing and impellers, flowlines and subsea flowlines.

Upstream oil and gas applications include the following: Process vessels and coating for process vessels including steam generation equipment, amine vessels, distillation towers, cyclones, catalytic crackers, general refinery piping, corrosion under insulation protection, sulfur recovery units, convection hoods, sour stripper lines, scrubbers, hydrocarbon drums, and other refinery equipment and vessels.

Pulp and paper applications include the following components: Rolls used in paper machines including yankee dryers, through air dryers, and other dryers, calendar rolls, machine rolls, press rolls, winding rolls, digesters, pulp mixers, pulpers, pumps, boilers, shredders, tissue machines, roll and bale handling machines, fiber guidance systems such as deflector blades, doctor blades, evaporators, pulp mills, head boxes, wire parts, press parts, M.G. cylinders, pope reels, winders, vacuum pumps, deflakers, and other pulp and paper equipment.

Power generation applications include the following components: boiler tubes, precipitators, fireboxes, turbines, generators, cooling towers, condensers, chutes and troughs, augers, bag houses, ducts, ID fans, coal piping, and other power generation components.

Agriculture applications include the following components: chutes, base cutter blades, sugar cane harvesting knives, hammers, troughs, primary fan blades, secondary fan blades, augers, components common to mining applications, and other agricultural applications.

Construction and architectural applications include the following: cement chutes, cement piping, bag houses, mixing equipment, structural components such as I-beams and concrete substitutes, flooring, kitchen counters, and other applications.

Machine element applications include the following components: Shaft journals, hydraulic cylinders, paper rolls, gear boxes, drive rollers, impellers, rebuilding of engine decks, propeller shafts and other shafts, general reclamation and dimensional restoration applications and other machine element applications

Steel applications include the following components: cold rolling mills, hot rolling mills, wire rod mills, galvanizing lines, continue pickling lines, continuous casting rolls and other steel mill rolls, and other steel applications.

Other applications include vehicle components for use in, e.g., engines, motors, automatic or manual transmissions, differentials, axles, brakes, and body parts; medical devices, such as, e.g., implantable devices, device housings, surgical equipment and surgical tools; aviation applications, such as turbines, fans, shafts, nozzles, propellers, fins, and other parts for propeller, jet, or rocket equipment, including fin, wing, tail and chassis parts.

Other applications include cold forming tools, drill bits for space mineral exploration, wire dies, inserts for sugar crushers, and crushers for oil sand applications.

### EXAMPLES

### Example 1 (Comparative)

An MMC article was made by liquid metal infiltration as follows. A portion of 230×450 mesh cast tungsten carbide (CTC) comprising spheroidal particles (aspect ratio: 1:1) was placed in a mold, and a portion of Cu53 comprising of a nominal composition of 53 wt. % Cu, 25 wt. % Mn, 15 wt, % Ni and 7 wt. % Zn was placed on top. The system was heated at 1180° C. for 0.25 hours and allowed to cool prior to testing to produce Article 1.

Article 1 exhibited a B611 volume loss of 675 mm³ (0.675 cc) and a Rockwell hardness of 49. The CTC powder exhibited a Vickers hardness (HV) of 2800-2960.

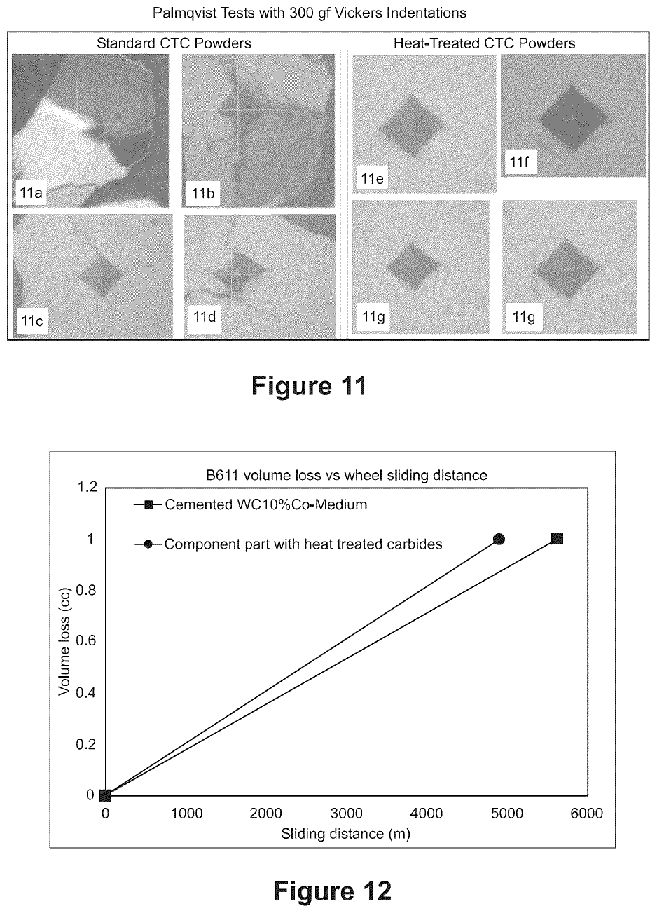

As shown in FIGS. 11a-11d, the CTC in Article 1 exhibited standard cracks and fractures when subject to the Palmqvist test with a Vickers indenter (300 gf).

### Example 2

The CTC powder as in Example 1 was placed in a vacuum furnace at 1225° C. for 20 hours and allowed to cool. Example 1 was then repeated, but using the heat treated CTC powder, to produce Article 2.

Article 2 exhibited a B611 volume loss of 557 mm³ (0.557 cc) and a Rockwell hardness of 49. The CTC powder exhibited a Vickers hardness (HV) of about 2125.

As shown in FIGS. 11e-11h, the CTC in Article 2 exhibited little to no fracturing (Palmqvist test) when subject to the Vickers indenter (300 gf).

### Examples 3-7

MMC articles in the form of 10 mm square bars were made by liquid metal infiltration as in Example 1, using tungsten carbides shown in Table 1 and the binder alloys shown in Table 2. WC-D is a spherical cast tungsten carbide with a textured surface. Examples 3-5 are comparative. Charpy impact toughness of the 10 mm square bars was tested according to ASTM E23, without a V-notch.

TABLE 1

| | | | Average | Particle |
|---|---|---|---|---|
| | | | Aspect | size (um) |
| | | wt % | Ratio | D50 |
| WC-C | angular cast tungsten carbide | 40 | 2.5 | 100 |
| | angular mono tungsten carbide | 60 | 2.5 | 25 |

| | | | |
|---|---|---|---|
| WC-D | 100 | 1.1 | 65 |

TABLE 2

| | Example 3 | Example 4 | Example 5 | Example 6 | Example 7 |
|---|---|---|---|---|---|
| tungsten | WC-C | WC-D | WC-D | WC-D | WC-D |
| carbide | | | | (25% HT) | (100% HT) |
| binder | Cu53 | Cu53 | MB1 | MB1 | MB1 |
| alloy | | | | | |
| Charpy | 3.3 | 5.9 | 9.2 | 11.5 | 13.7 |
| (ft · lb) | | | | | |

MB1: 85 wt % Cu, 8 wt % Mn, 5 wt % Ni, 2 wt % Sn
HT: Comprises the indicated wt % of heat-treated tungsten carbide powder, prepared by heat treatment at 1225° C. for 20 hours.

As seen in FIG. 11, the absence or reduction of cracks following Vickers indentation indicates that the CTC powder is unexpectedly toughened by the heat treatment process. As can be seen from the above Examples, use of heat-treated tungsten carbide powder surprisingly increases the toughness of the composite overall.

### Example 8

Coarse spherical cast tungsten carbides, with a grain size of 301 μm were heat-treated in a vacuum furnace at 1225° C. for 20 hours. The particles were placed in a mold and a portion of alloy having a nominal composition of 85 wt. % Cu, 8 wt. % Mn, 5 wt. % Ni and 2 wt. % Sn was placed on top. Infiltration was carried out at 1180° C. for 30 minutes. The component part was subjected to a high stress abrasion test, ASTM B611. A cemented tungsten carbide with 10 wt. % Cobalt and medium grain size tungsten carbide ranging from 1.4 to 3.4 μm is also tested for comparison.

As seen in FIG. 12, removal of 1 cm³ of material upon a sliding distance of 4902 m was achieved, which is similar to that observed for the compared cemented tungsten carbides. All testing protocols discussed or alluded to herein, such as ASTM testing procedures, are available and known to practitioners in this field.

While several components, techniques and aspects have been described with a certain degree of particularity, it is manifest that many changes can be made in the specific designs, constructions and methodology herein above described without departing from the spirit and scope of this disclosure.

Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as any subcombination or variation of any subcombination.

Moreover, while methods may be depicted in the drawings or described in the specification in a particular order, such methods need not be performed in the particular order shown or in sequential order, and that all methods need not be performed, to achieve desirable results. Other methods that are not depicted or described can be incorporated in the example methods and processes. For example, one or more additional methods can be performed before, after, simultaneously, or between any of the described methods. Further, the methods may be rearranged or reordered in other implementations. Also, the separation of various system components in the implementations described above should not be understood as requiring such separation in all implementations, and it should be understood that the described components and systems can generally be integrated together in a single product or packaged into multiple products. Additionally, other implementations are within the scope of this disclosure.

Conditional language, such as “can,” “could,” “might,” or “may,” unless specifically stated otherwise, or otherwise understood within the context as used, is generally intended to convey that certain embodiments include or do not include, certain features, elements, and/or steps. Thus, such conditional language is not generally intended to imply that features, elements, and/or steps are in any way required for one or more embodiments.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than or equal to 10% of, within less than or equal to 5% of, within less than or equal to 1% of, within less than or equal to 0.1% of, and within less than or equal to 0.01% of the stated amount. If the stated amount is 0 (e.g., none, having no), the above recited ranges can be specific ranges, and not within a particular % of the value. For example, within less than or equal to 10 wt./vol. % of, within less than or equal to 5 wt./vol. % of, within less than or equal to 1 wt./vol. % of, within less than or equal to 0.1 wt./vol. % of, and within less than or equal to 0.01 wt./vol. % of the stated amount.

Some embodiments have been described in connection with the accompanying drawings. The figures are drawn to scale, but such scale should not be limiting, since dimensions and proportions other than what are shown are contemplated and are within the scope of the disclosed inventions. Distances, angles, etc. are merely illustrative and do not necessarily bear an exact relationship to actual dimensions and layout of the devices illustrated. Components can be added, removed, and/or rearranged. Further, the disclosure herein of any particular feature, aspect, method, property, characteristic, quality, attribute, element, or the like in connection with various embodiments can be used in all other embodiments set forth herein. Additionally, it will be recognized that any methods described herein may be practiced using any device suitable for performing the recited steps.

While a number of embodiments and variations thereof have been described in detail, other modifications and methods of using the same will be apparent to those of skill in the art. Accordingly, it should be understood that various applications, modifications, materials, and substitutions can be made of equivalents without departing from the unique and inventive disclosure herein or the scope of the claims.

1. A tungsten carbide powder comprising granules having a grain boundary area fraction of 20%-50%, and an average aspect ratio of less than 1.3.

2. A method of treating the tungsten carbide powder of claim 1, comprising:
heating the tungsten carbide powder to a temperature of 1000-1250° C. for a period of 0.5-50 hours, under vacuum, in a non-reactive atmosphere or a reducing atmosphere.

3. The method of claim 2, wherein, after heating, the heat-treated tungsten carbides contain tungsten carbide (monocarbide) phase, metallic tungsten phase, wherein the tungsten phases comprise 1-50 wt. % of the heat-treated tungsten carbide powder.

4. The tungsten carbide according to claim 1, having a carbon content of between 3.0 and 4.5 wt. %.

5.-11. (canceled)

12. A metal matrix composite article comprising tungsten carbide particles in an alloy matrix,
wherein the tungsten carbide particles have a grain boundary area fraction of 20%-50%, and an aspect ratio of 1 to 1.3, and include 10 wt % to 100 wt % heat-treated tungsten carbide particles based on total weight of the tungsten carbide particles, and
the alloy matrix comprises 50-85 wt % copper.

13. The metal matrix composite article of claim 12, that exhibits a wear resistance of 6 mm³ or less, when measured according to ASTM G65.

14. The metal matrix composite article of claim 12, that exhibits a volume loss of 0.8 cc lor less, when measured according to ASTM B611.

15. The metal matrix composite article of claim 12, that exhibits a Charpy impact toughness of at least 6.8 J.

16. The metal matrix composite article of claim 12, wherein the tungsten carbide particles have a D50 of between 1 μm and 10 μm, and a TRS greater than or equal to 360 ksi.

17. The metal matrix composite article of claim 12, wherein the tungsten carbide particles have a D50 of between 11 μm and 20 μm, and a TRS greater than or equal to 280 ksi.

18. The metal matrix composite article of claim 12, wherein the tungsten carbide particles have a D50 of between 21 μm and 80 μm, and a TRS greater than or equal to 230 ksi.

19.-20. (canceled)

21. The metal matrix composite article of claim 12, wherein the tungsten carbide particles have a D50 of between 81 μm and 100 μm, and a TRS greater than or equal to 140 ksi.

22. The metal matrix composite article of claim 12, wherein the tungsten carbide particles have a D50 of between 61 μm and 200 μm, and a TRS greater than or equal to 100 ksi.

23. The metal matrix composite article of claim 12, wherein the tungsten carbide particles have a D50 of between 201 μm and 1000 μm, and a TRS greater than or equal to 80 ksi.

24. (canceled)

25. The metal matrix composite article of claim 12, wherein the tungsten carbide particles have a D50 of between 1001 μm and 2000 μm, and a TRS greater than or equal to 50 ksi.

26. The metal matrix composite article of claim 12, wherein the tungsten carbide particles include 10 wt % to 100 wt % heat-treated tungsten carbide particles, based on the total weight of the tungsten carbide particles.

27.-30. (canceled)

31. The metal matrix composite article of claim 12, wherein the alloy matrix further comprises 1.4-2.6 wt % Sn, 5.6-10.4 wt. % Mn, and 3.5-6.5 wt % Ni.

32. The metal matrix composite article of claim 12, wherein the composite comprises a first region where the metal matrix composite is a high strength matrix metal composite material, and a second region where the metal matrix composite is a high abrasion resistant matrix metal composite material.

33. The metal matrix composite article of claim 12, wherein the matrix metal composite article comprises a plurality of regions, each region comprising 10 wt % to 100 wt % of the heat-treated tungsten carbide particles based on total weight of the tungsten carbide particles in the respective region.

34. (canceled)

35. The method of claim 3, wherein, after heating, the heat-treated tungsten carbides further contain hemicarbide (W2C) phase.
